(19) United States
(12) Patent Application Publication
(10) Pub. No.: US 2008/0197962 A1
(43) Pub. Date: Aug. 21, 2008

(54) MULTIPLE-PRIMARY HIGH FREQUENCY TRANSFORMER INVERTER

(76) Inventors: Casper Jan-Theo STEENKAMP, Saskatoon (CA); Nathan Wiebe, Saskatoon (CA); Michael Patrick Bradley, Saskatoon (CA)

Correspondence Address: LAW OFFICES OF ALBERT WAI-KIT CHAN, PLLC, WORLD PLAZA, SUITE 604, 141-07 20TH AVENUE, WHITESTONE, NY, 11357, US

(21) Appl. No.: 11/962,250

(22) Filed: Dec. 21, 2007

(30) Foreign Application Priority Data
Dec. 22, 2006 (CA) 2,572,046

(51) Int. Cl. H01F 27/28; H02K 19/36

(52) U.S. Cl. 336/170; 310/68 D

(57) ABSTRACT

A transformer based inverter system comprises a transformer core, a secondary winding wound around the transformer core, a plurality of primary winding circuits each comprising a clockwise or counterclockwise winding wound around the transformer core and a switch operative to selectively open and close to allow current to flow through the winding. Each primary winding circuit is connected to terminals of a DC generator to drive current around the transformer core in a clockwise or counterclockwise direction. A control system is operative to open and close the switches such that an input DC voltage from a generator is transformed and inverted into an AC voltage that has a frequency and voltage equal to a desired frequency and voltage, and such that as the input DC voltage varies within a range, the AC voltage at the terminal ends of the secondary winding remains substantially constant.

This invention is in the field of electric power generation and in particular a transformer based inverter system for transferring a direct current electric power output from a generator to an alternating current (AC) load.

### BACKGROUND

Wind powered turbines provide clean energy and are becoming popular. Since wind speed varies, the voltage of the electrical power generated can vary dramatically and erratically, and problems arise in harnessing the energy provided by a wind turbine. For example a simple wind powered electrical generator might have a direct current (DC) output of 0-600 volts, depending on the wind speed. Connecting this generator to a 120 or 240 volt alternating current (AC) load or a utility grid for the purpose of power export presents considerable challenges. Similarly the voltage of other renewable sources, such as the power generated by photovoltaic cells varies with the cloud cover, changing orientation of the sun, and like factors, has similar challenges.

An inverter system must work efficiently over a very wide range of direct current (DC) input voltages in order to take electrical power generated at a range of voltages and transform same such that the energy can be fed into a power grid.

It is presently problematic to provide the range of voltage step-ups or step-downs needed for transferring electrical power generated from solar or wind sources into an electrical utility grid tie-in or off-grid alternating current (AC) applications where a fixed frequency and voltage are required, with present systems. For example simple fixed-ratio high frequency (HF) transformer inverter and conventional switch mode boost, buck, or buck-boost inverter systems have a limited input voltage operating range.

### SUMMARY OF THE INVENTION

It is an object of the present invention to provide a high frequency transformer based inverter system for transferring a direct current (DC) electrical power output from a generator to an alternating current (AC) load that overcomes problems in the prior art.

The present invention provides a transformer based inverter system for transferring a direct current (DC) electrical power output from a generator with first and second output terminals to an alternating current (AC) load. The system comprises a transformer core, a secondary winding wound around the transformer core, a plurality of clockwise primary winding circuits each comprising a clockwise winding wound around the transformer core and a switch operative to selectively open and close to allow current to flow through the clockwise winding, and a plurality of counterclockwise primary winding circuits each comprising a counterclockwise winding wound around the transformer core and a switch operative to selectively open and close to allow current to flow through the counterclockwise winding. An end of each primary winding circuit is adapted to be connected to the first terminal of the generator, and an opposite end of each primary winding circuit is adapted to be connected to the second terminal of the generator. The clockwise and counterclockwise windings, and connections of the ends of the primary winding circuits to the terminals of the generator, are configured such that current flows around the transformer core in a first direction through the clockwise windings and in an opposite second direction through the counterclockwise windings. A control system is connected to the switches and is operative to open and close the switches such that an input DC voltage from the generator is transformed and inverted into an AC voltage at terminal ends of the secondary winding that has a frequency and voltage substantially equal to a desired frequency and voltage, and such that as the input DC voltage varies within a range, the AC voltage at the terminal ends of the secondary winding is sufficient to drive a desired current through a load.

Thus the present invention provides a HF transformer with a secondary winding and a plurality of clockwise and counterclockwise primary windings configured such that a DC current switched between clockwise and counterclockwise windings will induce an AC current in the secondary winding of the transformer.

The terms “clockwise” and “counterclockwise” as applied to the primary windings refers to the direction of current flow through the windings. The current flows around the transformer core in one direction through the clockwise winding, and in the opposite direction through the counterclockwise winding. To accomplish this the primary windings can be wrapped around the transformer core in opposite directions, or the ends of the clockwise and counterclockwise primary winding circuits can be connected to terminals of the generator that have opposite polarity.

The primary windings are preferably provided in pairs, where a pair is defined as a set of two windings that have equal numbered turns but are connected so current flows around the transformer core in opposite directions (clockwise and counter-clockwise). A plurality of pairs are provided, and the different pairs have different numbers of turns. The windings can be designed to provide a step-up and/or step-down voltage transformation. In this way a specific voltage level transformation is achieved across the transformer by engaging a specific turns-ratio in pulse width modulated (PWM) action.

Each primary winding has an associated switch, which may comprise power transistors such as field effect transistors (FETs), insulated gate bipolar transistors (IGBTs), or other devices designed to switch electrical loads. A switch opens or closes to stop or initiate, respectively, an electrical current flow through a winding. Each primary winding and its associated switch thus provide a primary winding circuit which can be connected to a generator, and a control is provided that operates the switch in each circuit to either allow current to flow through the winding or stop the flow as desired.

The HF transformer secondary winding is tied to a low-pass filter which allows the low frequency (utility grid frequency) component of the transformed power to be transferred to or from a load, whether that load is an electrical utility grid or an otherwise isolated attachment.

Many types of pulse width modulated (PWM) control methods could be implemented with the invention topology, depending on the particular application in which the invention is being used. A bidirectional energy flow capability allows the inverter to be implemented in either grid-tie or off-grid applications.

### DESCRIPTION OF THE DRAWINGS

While the invention is claimed in the concluding portions hereof, preferred embodiments are provided in the accompanying detailed description which may be best understood in conjunction with the accompanying diagrams where like parts in each of the several diagrams are labeled with like numbers, and where:

FIG. 1 is a schematic block diagram of an embodiment of a transformer based inverter system of the present invention;

FIG. 2 illustrates a delta-modulated sine wave current for grid-tie applications;

FIG. 3 illustrates a modified delta-modulated sine wave current for grid-tie applications where T_{H} is a positive and T_{L} a negative polarity turns ratio on the primary winding;

FIG. 4 schematically illustrates an alternate arrangement for providing clockwise and counterclockwise primary windings.

### DETAILED DESCRIPTION OF THE ILLUSTRATED EMBODIMENTS

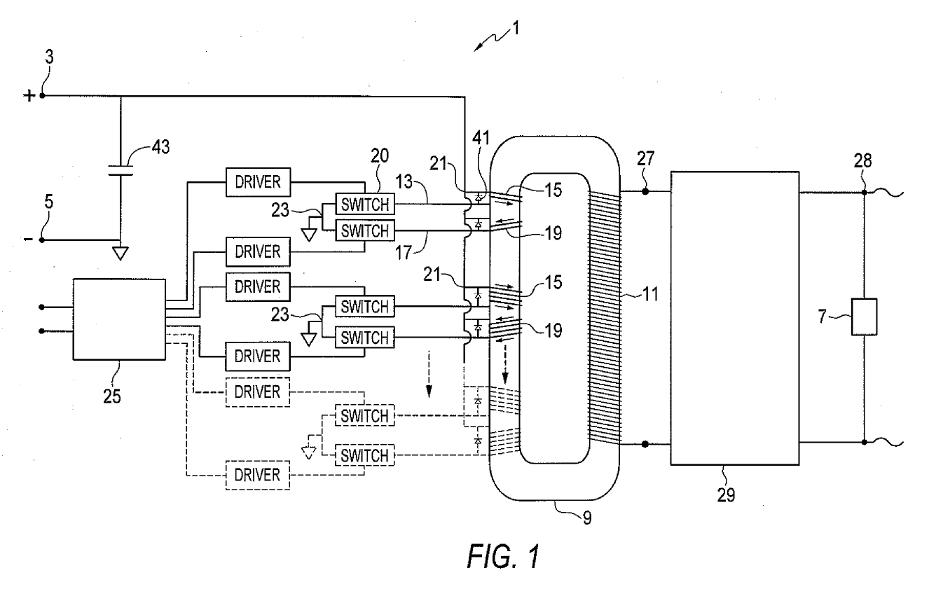

FIG. 1 schematically illustrates a transformer based inverter system 1 of the present invention. The system 1 is operative to transfer a direct current (DC) electrical power output from a generator with first and second output terminals 3, 5 to an alternating current (AC) load 7.

The system 1 comprises a transformer core 9, and a secondary winding 11 wound around the transformer core 9. A plurality of clockwise primary winding circuits 13 each comprises a clockwise winding 15 wound around the transformer core 9 and a switch 20 operative to selectively open and close to allow current to flow through the clockwise winding 15. A plurality of counterclockwise primary winding circuits 17 each comprises a counterclockwise winding 19 wound around the transformer core 9 and a switch 20 operative to selectively open and close to allow current to flow through the counterclockwise winding 19.

In the illustrated embodiment of FIG. 1, the primary windings 15, 19 are wrapped around the transformer core 9 in opposite directions. A first end 21 of each primary winding circuit 13, 17 is adapted to be connected to the first terminal 3 of the generator, and the second end 23 of each primary winding circuit 13, 17 is connectable to the second terminal 5 of the generator. In the illustrated embodiment of the system 1, the first generator terminal 3 is shown as the positive polarity terminal, and the second generator terminal 5 is shown as the negative polarity terminal, and is connected to the second end of the primary winding circuits 13, 17, for convenience of illustration, through ground. Thus when a voltage is present at the generator terminals 3, 5 each primary winding circuit 13, 17 can pass current therethrough when the switch 20 in the particular circuit is closed. In practice it is contemplated that, instead of being grounded, ends 23 of the primary winding circuits 13, 17 will be tied to terminal 5.

The clockwise and counterclockwise windings 15, 19, and connections of the ends of the primary winding circuits 13, 17 to the terminals 3 and 5 of the generator, are configured such that current flows around the transformer core 9 in a first direction through the clockwise windings 15 and in an opposite second direction through the counterclockwise windings 19 as indicated by the arrows in FIG. 1.

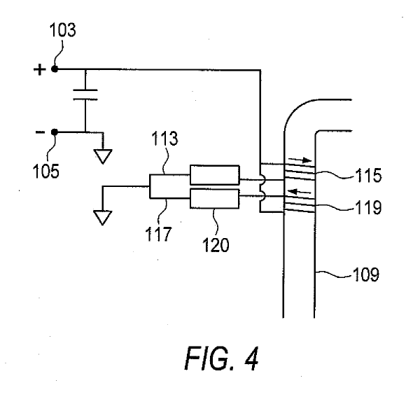

Instead of wrapping the clockwise and counterclockwise primary windings 15, 19 around the transformer core 9 in opposite directions, as illustrated in FIG. 1, the ends of the clockwise primary winding circuits can be connected to terminals of the generator that have opposite polarity compared to the connection to the counterclockwise primary winding circuits, as schematically illustrated in FIG. 4. In FIG. 4 the top end of the clockwise primary winding 115 of the clockwise primary winding circuit 113 is connected to the positive terminal 103 of the generator, while the bottom end thereof is connected through ground to the negative terminal 105. In contrast the bottom end of the counterclockwise primary winding 119 of the counterclockwise primary winding circuit 117 is connected to the positive terminal 103 of the generator, while the top end thereof is connected through ground to the negative terminal 105. In this manner the system is also configured so that current flows through the clockwise and counterclockwise windings 115, 119 in opposite directions, as indicated by the arrows.

Thus the terms “clockwise” and “counterclockwise” as applied to the primary windings refers to the direction of current flow through the windings. The current flows around the transformer core in one direction through the clockwise winding, and in the opposite direction through the counterclockwise winding. To accomplish this the primary windings can be wrapped around the transformer core in opposite directions, as shown in FIG. 1, or the ends of the clockwise and counterclockwise primary winding circuits can be connected to terminals of the generator that have opposite polarity, as illustrated in FIG. 4.

A control system 25 is connected to the switches 20 and is operative to open and close the switches 20 such that an input DC voltage from the generator is transformed and inverted into an AC voltage at terminal ends 27 of the secondary winding 11 that has a frequency and voltage substantially equal to a desired frequency and voltage, and such that as the input DC voltage at the generator terminals 3, 5 varies within a range, the AC voltage at the terminal ends 27 of the secondary winding 11 remain substantially constant.

Thus the system 1 is well suited to renewable energy generating sources, such as wind powered turbines, photovoltaic cells, and the like. Such generators produce DC power where the voltage varies with wind speed, solar conditions, and like uncontrollable factors. The range of varying input voltage will vary for different applications but can be quite large. For example a typical small scale wind generator might generate power at close to 0 Volts DC up to a maximum of 600 Volts DC volts, and the system 1 can be configured to actively ensure that power can substantially always be transferred to the grid.

In the system illustrated in FIG. 1 the load 7 could be a utility grid that is isolated from the secondary winding terminals 27 by a low-pass filter 29 such as is known in the art. Alternatively an isolated load, such as an off-grid residence, or the like, could receive the power from the generator through the system 1.

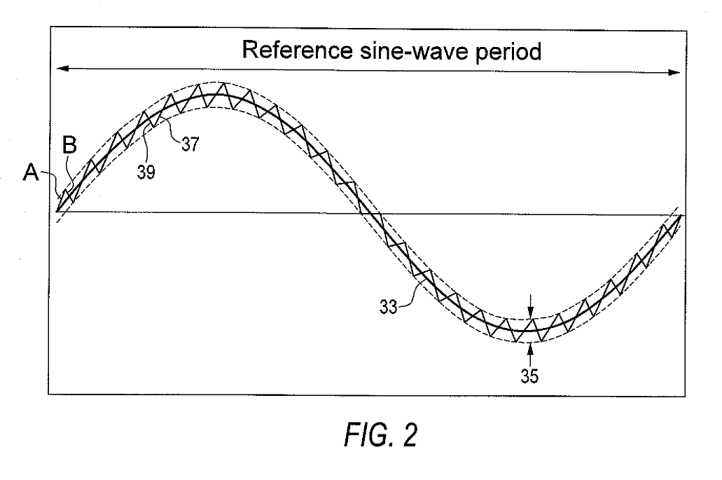

Converting DC to AC with this setup can be controlled by a PWM scheme such as Delta Modulation (DM). In a DM method the output current or voltage is controlled so as to follow a reference sinusoid 33 within a certain acceptance band 35 as illustrated in FIG. 2.

The control system 25 operates the switches 20 to provide current or voltage ramps through the low-pass filter 29. Closing the switch 20 in a clockwise primary winding circuit 13 provides positive ramps 37 through the filter 29 while closing the switch 20 in a counterclockwise primary winding circuit 17 provides negative ramps 39 through the filter 29 as seen in FIG. 2. When a switch 20 opens, a flyback diode 41 connected across the windings 15, 19 will feed any flyback currents back to charge the DC link capacitor 43.

At any particular point of the sinusoid 33, the correct clockwise or counterclockwise winding is selected to drive current or voltage ramps 37, 39 within the limits of the acceptance band 35. It is contemplated that for ease of design the clockwise and counterclockwise windings 15, 19 will be provided in pairs, with each pair comprising a clockwise winding primary winding circuit 13 with a clockwise winding 15 and switch 20, and a counterclockwise winding primary winding circuit 17 with a counterclockwise winding 19 and switch 20, where the windings 15 and 19 have the same number of turns. Given a particular generator DC input voltage which remains significantly constant over the period of a single low frequency cycle (grid frequency), a single particular pair of windings can be used to perform DM for the entire cycle and that particular input voltage. However, it is contemplated that in a more sophisticated control scheme a variety of clockwise and counterclockwise windings 15, 19 with different turns could be used during a single low frequency cycle so as to minimize total harmonic distortion (THD), so long as the number of windings is known. The control system 25 is then operative to open a switch 20 in a circuit in a first pair of primary winding circuits, and then close a switch 20 in a circuit in a second pair of primary winding circuits.

Delta modulation provides a good approximation to a sine wave as the controlled quantity is the ramp rate of the injected current rather than the current level itself. Thus when the current set point is far from its required value, the ramp rate, or the slope of the current ramps 37, 39, is steep, whereas when the set point is nearer to the correct value the slope levels off. The effective frequency of delta modulation is not constant but varies upon the position within the waveform. The maximum delta modulation frequency should be high enough to attain the desired current THD and allow the optimization of components that are employed in 29. A practical maximum DM frequency is typically 3 orders of magnitude larger than the fundamental frequency at the load.

In a grid-tied current controlled embodiment the zero crossing of the grid voltage waveform is used to synchronize the waveform with the reference sinusoid 33. The ramp rate of the output current is controlled by the difference between the transformed voltage and the corresponding grid voltage on the other side of the filter 29 across the load 7 at filter output 28.

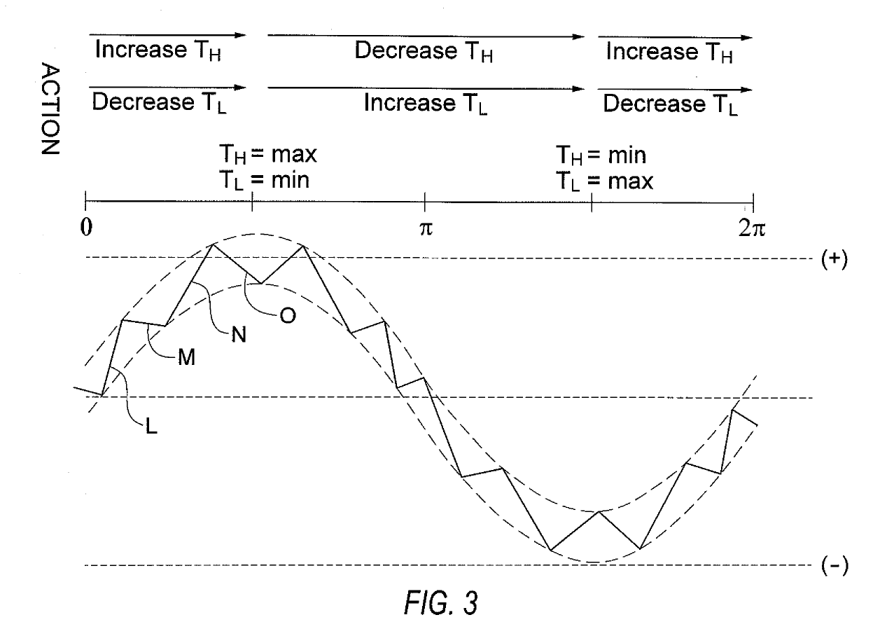

The wave form illustrated in FIG. 3 can be provided by a single pair of primary windings 15, 19 where the step up transformation is such that the voltage at secondary terminals 27 is greater than the maximum of the grid voltage. For example where the grid is operating at 120 volts, the peak voltage of the reference curve 33 will be 170 volts for a voltage sine wave with zero THD. While the DC voltage at the generator terminals 3, 5 will vary significantly over time, during the one cycle interval shown in FIG. 3, equal to 1/60 second, the voltage is for practical purposes constant.

Thus if the voltage V_{gen} is 100 volts, a step of twice will give a maximum voltage of 200 volts, well above the grid voltage. Thus turning on the switch 20 in the positive clockwise primary winding circuit 13 will cause the current to climb from zero, at the left side of FIG. 3 as indicated by upward sloping line A, until it hits the top of the acceptance band 35, at which time the control 25 will “flip flop”, and turn off the switch 20 in the clockwise primary winding circuit 13 and turn on the switch 20 in the negative counterclockwise primary winding circuit 17, causing the voltage to go down, as indicated by downward sloping line B in FIG. 3. Again when the voltage hits the bottom of the acceptance band the control 25 will flip flop again, closing the positive clockwise primary winding circuit 13 and the current will climb again to the top of the acceptance band 35, as illustrated by sloping line C. In this manner the single pair of primary winding circuits 13, 17 can provide the current curve illustrated in FIG. 3.

It is contemplated as well that instead of turning a counterclockwise primary winding circuit on when a clockwise primary winding circuit is turned off, or vice versa, all switches could be turned off so that the current “free falls” to the bottom of the acceptance band 35, at which time the clockwise primary winding circuit is again turned on. In this manner as well a waveform within the acceptance band 35 may be accomplished as well.

The control 25 is configured to sense the voltage V_{gen} at the generator terminals 3, 5 and also to sense the current induced in the secondary winding 27. The control 25 is thus able to know the voltage V_{gen} that it has to transform, and is synchronized to the grid.

FIG. 3 illustrated an alternate more sophisticated control operation. Since a plurality of clockwise and counterclockwise primary windings are provided in order to deal with varying voltages at the generator terminals, the control can be configured to select any individual coil at any given time to provide a suitable ramp rate, or to turn all switches 20 off, as discussed above. In FIG. 4 the switch in a first positive primary winding circuit is turned on to produce the voltage ramp L, while a first negative primary winding circuit is turned on to produce voltage ramp M. The positive and negative primary winding circuits are not necessarily from the same pair, but can be any windings that the control 25 finds are suitable for the generator voltage and position on the sine wave at any given time. Again, a different positive primary winding circuit is then turned on to produce the voltage ramp N, and another negative primary winding circuit is turned on to produce voltage ramp O.

FIG. 4 indicates how, generally speaking, the turns ratio T_{H} of the positive primary winding circuit closed may be increased as the wave moves up from zero to the positive peak, while at the same time the turns ratio T_{L} of the negative primary winding circuit closed may be decreased as the wave moves up from zero to the positive peak. Then as the wave moves down from the positive peak to the negative peak, the turns ratio T_{H} of the positive primary winding circuit closed may be decreased, while at the same time the turns ratio T_{L} of the negative primary winding circuit closed may be increased. The system of FIG. 4 thus provides smoother operation with reduced harmonic distortion by optimizing DM ramp rates.

Two secondary windings can be included so as to make provision for both North American (120Vrms) and European/Continental (240Vrms) grids. If a 120Vrms output is required, one secondary winding is, or both in parallel are, employed. For 240Vrms grid-tie applications, the two secondary windings are connected in series and treated as one winding. A plurality of inverter systems 1 can be used in parallel to increase the current output capacity of the inverter action.

Where the lower operating frequency of a voltage source included in the load (such as a utility grid) threatens to saturate the HF transformer core, a full-wave rectification stage and line frequency switching full bridge may be inserted between the HF transformer and low pass filter to block reverse current from the grid.

The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

What is claimed is:

1. A transformer based inverter system for transferring a direct current (DC) electrical power output from a generator with first and second output terminals to an alternating current (AC) load, the system comprising:
a transformer core;
a secondary winding wound around the transformer core;
a plurality of clockwise primary winding circuits each comprising a clockwise winding wound around the transformer core and a switch operative to selectively open and close to allow current to flow through the clockwise winding; and
a plurality of counterclockwise primary winding circuits each comprising a counterclockwise winding wound around the transformer core and a switch operative to selectively open and close to allow current to flow through the counterclockwise winding;
an end of each primary winding circuit adapted to be connected to the first terminal of the generator;
an opposite end of each primary winding circuit adapted to be connected to the second terminal of the generator;
wherein the clockwise and counterclockwise windings, and connections of the ends of the primary winding circuits to the terminals of the generator, are configured such that current flows around the transformer core in a first direction through the clockwise windings and in an opposite second direction through the counterclockwise windings;
a control system connected to the switches and operative to open and close the switches such that an input DC voltage from the generator is transformed and inverted into an AC voltage at terminal ends of the secondary winding that has a frequency and voltage substantially equal to a desired frequency and voltage, and such that as the input DC voltage varies within a range, the AC voltage at the terminal ends of the secondary winding is sufficient to drive a desired current through a load.

2. The system of claim 1 wherein the clockwise windings are wound around the transformer core in a first direction, and the counterclockwise windings are wound around the transformer core in an opposite second direction.

3. The system of claim 1 wherein the clockwise and counterclockwise primary winding circuits are connected to terminals of the generator with opposite polarities.

4. The system of claim 1 wherein the control system comprises at least one voltage sensor operative to detect a voltage at a selected location in the system.

5. The system of claim 4 wherein the selected location includes the output terminals of the generator.

6. The system of claim 1 comprising pairs of primary winding circuits, each pair of primary winding circuits comprising a clockwise primary winding circuit and a counterclockwise primary winding circuit that have equal numbered turns.

7. The system of claim 6 wherein the control system is operative to open a switch in a circuit in a first pair of primary winding circuits, and then close a switch in a circuit in a second pair of primary winding circuits.
